(19) United States
(12) Patent Application Publication
(10) Pub. No.: US 2009/0009564 A1
(43) Pub. Date: Jan. 8, 2009

(54) ELECTROSTATIC ACTUATOR, DROPLET DISCHARGE HEAD, MANUFACTURING METHOD OF ELECTROSTATIC ACTUATOR AND MANUFACTURING METHOD OF DROPLET DISCHARGE HEAD

(75) Inventor: Seiji Yamazaki, Shimosuwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/127,150

(22) Filed: May 27, 2008

(30) Foreign Application Priority Data
Jul. 6, 2007 (JP) 2007-178918

(51) Int. Cl. B41J 2/045

(52) U.S. Cl. 347/70

(57) ABSTRACT

An electrostatic actuator includes a vibration plate, and a counter electrode facing the vibration plate and spaced apart therefrom by a gap. The vibration plate is in a multistage shape in such a manner that the thickness is increased gradually from a central portion toward the outer periphery of the vibration plate.

### BACKGROUND OF THE INVENTION

1. Technical Field

The present invention relates to an electrostatic actuator, a droplet discharge head, a manufacturing method of the electrostatic actuator and a manufacturing method of the droplet discharge head.

2. Related Art

As an example of a droplet discharge head for discharging a droplet, there is an inkjet head having an electrostatic actuator.

This kind of an inkjet head includes a cavity substrate having a discharge chamber formed therein, an electrode glass substrate that is bonded to the cavity substrate and has a recess on which is formed a discrete electrode disposed facing a vibration plate with a gap interposed therebetween, and a nozzle substrate that is bonded on a surface of the cavity substrate opposite to the surface with the electrode glass substrate bonded thereon and that has nozzle holes formed therein.

The bottom wall of the discharge chamber is formed as an elastic deformable vibration plate.

By applying a drive voltage between this vibration plate and the discrete electrode, electrostatic force is generated.

The electrostatic force deforms the vibration plate, causing a droplet to be discharged from a nozzle hole.

Here, when the inkjet head is driven to cause the vibration plate to repeatedly operate, a crack and a breakdown are generated.

Specifically, stress is concentrated on a boundary (connection portion) between a partition constituting the wall surface of the discharge chamber and the vibration plate.

Due to the concentration of stress, a crack is generated in the connection portion.

As techniques to prevent the generation of a crack caused by repeating operations of the vibration plate, techniques of forming a slope in the connection portion between the partition and the vibration plate to reduce the stress applied onto the connection portion have hitherto been proposed (refer to, e.g., JP-A-11-129473 (FIG. 5) and JP-A-11-277742 (FIG. 1)).

With these techniques, the concentration of stress on the connection portion of the partition and the vibration plate can be reduced, improving the durability of the connection portion.

However, as an electrostatic actuator that is small-sized, has high density, and can be driven by low voltage has been demanded in recent years, reducing the thickness of a vibration plate has been required.

Due to the reduction of the thickness, a vibration plate is likely to be broken.

Therefore, there has been a problem in that a sufficient breakdown-prevention effect cannot be obtained only by applying the foregoing related art techniques to such a vibration plate.

### SUMMARY

An advantage of the present invention is to provide an electrostatic actuator having improved durability for repeating operations of a vibration plate and high reliability.

Other advantages of the invention are to provide a droplet discharge head including this electrostatic actuator and to provide their manufacturing methods.

An electrostatic actuator according to a first aspect of the invention includes a vibration plate, and a counter electrode facing the vibration plate and spaced apart therefrom by a gap.

The vibration plate is in a multistage shape in such a manner that a thickness is increased gradually from the central portion toward the outer periphery of the vibration plate.

Here, the central portion of the vibration plate is to be formed having a thickness necessary and sufficient to meet the demand for high density.

The structure of gradually increasing the thickness from the central portion toward the outer periphery can relax the entire stress of the vibration plate and also can enhance the rigidity of a connection portion of the vibration plate and a portion supporting the vibration plate.

This allows prevention of a crack of the vibration plate caused by repeating operations.

As a result, the durability for the repeating operations of the vibration plate improves, allowing the vibration plate with improved reliability in the long term to be obtained.

In the electrostatic actuator according to the first aspect of the invention, a slope may be formed in a connection portion of the vibration plate and a portion supporting the vibration plate.

Thus, the stress in the connection portion can be reduced, enabling further improvement of the durability.

In the electrostatic actuator according to the first aspect of the invention, the vibration plate may be made of a boron-doped silicon substrate.

Thus, the thickness of the vibration plate can be controlled with high precision, enabling stable drive of the electrostatic actuator.

In the electrostatic actuator according to the first aspect of the invention, an electrode substrate on which the counter electrode is formed may be made of borosilicate glass.

Thus, when a substrate (cavity substrate) having a vibration plate made of silicon is bonded with the electrode substrate, displacement caused by heat can be prevented because their coefficients of expansion are not largely different.

They can also be easily bonded by anodic bonding.

In the electrostatic actuator according to the first aspect of the invention, the counter electrode may be made of indium tin oxide (ITO).

ITO is transparent and therefore has advantages such as being able to confirm the discharging state during anodic bonding of the electrode substrate with the vibration plate made of silicon.

A droplet discharge head according to a second aspect of the invention includes the electrostatic actuator according to the first aspect of the invention.

In this droplet discharge head, the vibration plate constitutes a bottom wall of a discharge chamber for discharging a droplet.

Thus, the droplet discharge head having high durability for the repeating operations of the vibration plate and high reliability in the long term can be obtained.

A method for manufacturing an electrostatic actuator according to a third aspect of the invention includes forming a boron-doped layer by repeating a process of selectively diffusing boron into a silicon substrate, and forming a vibration plate by wet etching of the silicon substrate having the boron-doped layer formed therein and stopping the etching with the boron-doped layer.

Thus, a multistage shape of the vibration plate can be formed with good precision, enabling the entire stress of the vibration plate to be relaxed.

As a result, the durability of the vibration plate can be improved.

In the method for manufacturing an electrostatic actuator according to the third aspect of the invention, the wet etching may be performed using potassium hydroxide aqueous solutions having different concentrations.

In this way, a slope can be formed in a connection portion of the vibration plate and its supporting portion, reducing the concentration of stress on the connection portion.

This allows further improvement in durability of the vibration plate, such as preventing a crack in the vibration plate.

A method for manufacturing a droplet discharge head according to a fourth aspect of the invention includes forming an actuator portion of a droplet discharge head by applying the method for manufacturing an electrostatic actuator according to the third aspect of the invention.

Thus, a droplet discharge head having high durability for the repeating operations of the vibration plate and having high reliability in the long term can be obtained.

### BRIEF DESCRIPTION OF THE DRAWINGS

The invention will be described with reference to the accompanying drawings, wherein like numbers reference like elements.

FIG. 1 is an exploded perspective view of an inkjet head according to one embodiment of the invention.

FIG. 2 is a sectional view of the inkjet head of FIG. 1.

FIG. 3 is a plan view of a discharge chamber portion of a cavity substrate of FIG. 1.

FIG. 4 shows another arrangement of a vibration plate, in which the vibration plate is in a multistage shape.

FIGS. 5A to 5F show a method for manufacturing a cavity substrate (1/2).

FIGS. 6G to 6K show the method for manufacturing a cavity substrate (2/2).

FIGS. 7A to 7G show processes for manufacturing an inkjet head, following FIGS. 6G to 6K (1/2).

FIGS. 8H to 8N show the processes for manufacturing an inkjet head, following FIGS. 7A to 7G (2/2).

FIG. 9 is a graph showing a relationship between the height of a slope formed in a connection portion of a vibration plate and a partition and the KOH concentration.

FIG. 10 is an explanatory view of the height of the slope of FIG. 9.

### DESCRIPTION OF EXEMPLARY EMBODIMENT

A droplet discharge head including an electrostatic actuator according to an embodiment of the invention will be described below.

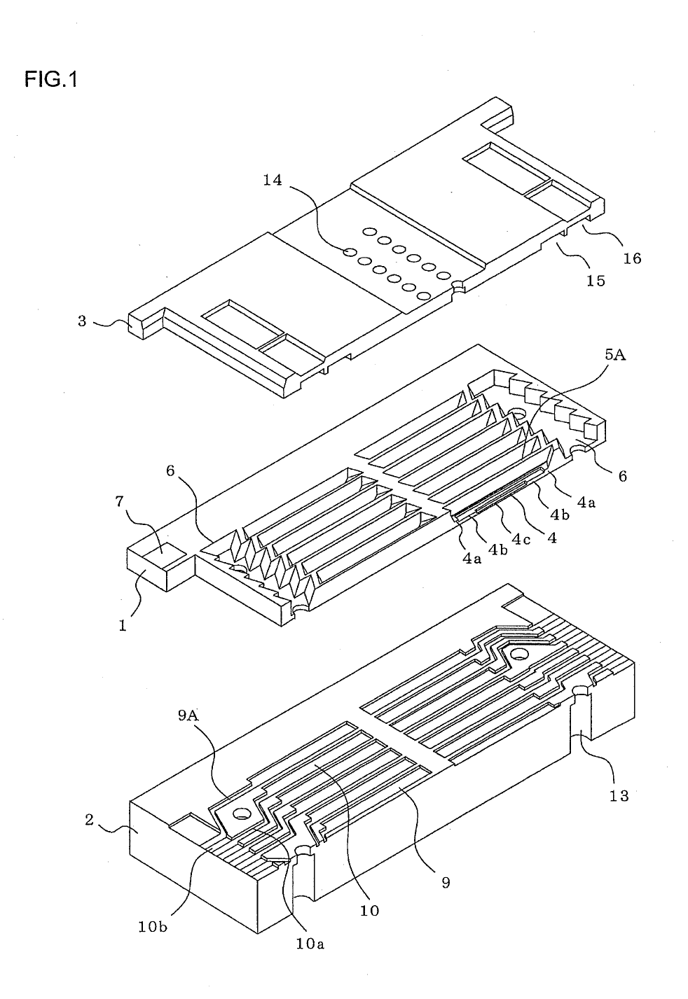

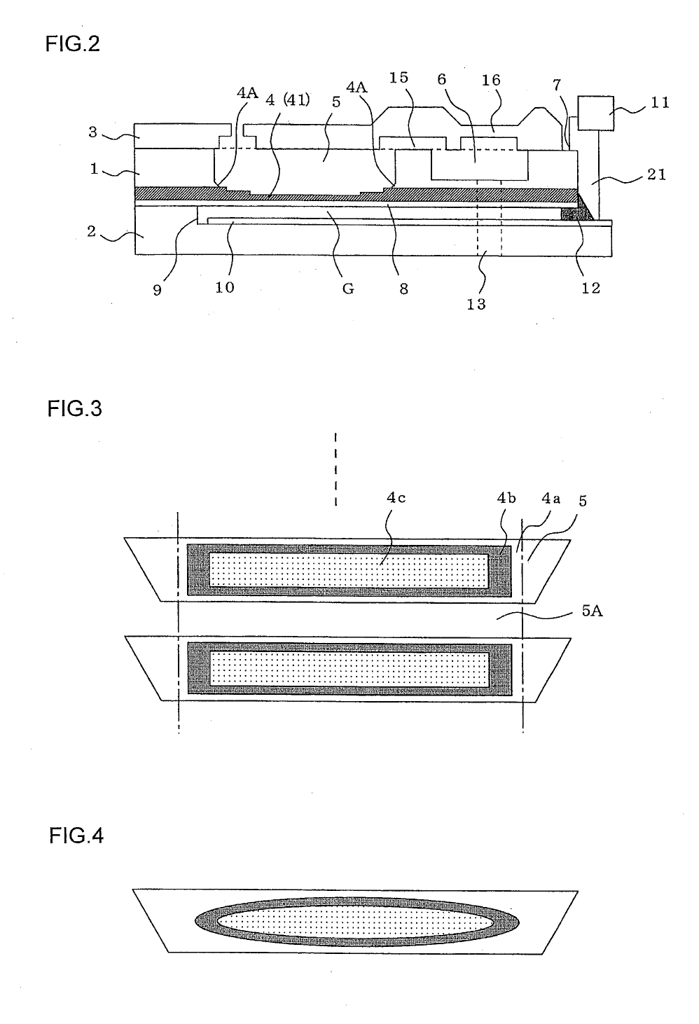

Note that, here, a face-discharge type inkjet head that discharges an ink droplet from an ink nozzle provided on the surface of a nozzle substrate is described as an exemplary droplet discharge head with reference to FIGS. 1 and 2.

Note also that the invention is not limited to the structures and shapes shown in drawings described below and may be applied to an edge-discharge type inkjet head that discharges an ink droplet from an ink nozzle provided in an end of a substrate.

FIG. 1 is an exploded perspective view of an inkjet head according to one embodiment of the invention.

FIG. 2 is a sectional view of the inkjet head of FIG. 1.

FIG. 3 is a plan view of a discharge chamber portion of a cavity substrate of FIG. 1.

Note that, in order to allow components to be shown in the drawings and to make them easily visible, the size relationship among components may be different from the actual size relationship in the drawings described below including FIG. 1.

Note also that the description hereinafter is given supposing that the upper side and the lower side shown in the drawings are the “upper side” and the “lower side”, respectively, the direction along which nozzles are arranged is the “transverse direction”, and the direction perpendicular to the transverse direction is the “longitudinal direction”.

An inkjet head according to the present embodiment is in a three-layer structure composed of a cavity substrate 1, an electrode glass substrate 2 and a nozzle substrate 3.

The cavity substrate 1 is made, e.g., of a silicon single-crystal substrate (hereinafter, referred to simply as a “silicon substrate”) of a (110) surface orientation with a thickness of about 50 μm.

The silicon substrate is etched by anisotropic wet etching, thereby forming discharge chambers 5, whose bottom walls serve as vibration plates 4, and reservoirs 6 for storing the liquid discharged commonly by all discharge chambers.

An electrode terminal 7 is formed on the cavity substrate 1 and is connected to an oscillation circuit 11 shown in FIG. 2.

Here, an insulating film 8 is formed on the lower surface (the surface facing the electrode glass substrate 2 of the cavity substrate 1.

The insulating film 8 is provided in this example by depositing a tetraethyl orthosilicate tetraethoxysilane (TEOS) film having a thickness of 0.1 μm by a plasma chemical vapor deposition (CVD) method.

This is for the purpose of preventing dielectric breakdown and short circuit when driving an inkjet head.

The vibration plate 4 is made in a multistage shape (three-stage structure in this example) in which the thickness of the central portion is necessarily and sufficiently thin so as to meet the demand for high density of an electrostatic actuator and the thickness is increased gradually toward the outer periphery.

With such a structure, the entire stress of the vibration plate 4 is relaxed and the rigidity of the connection portion sides of the vibration plate 4 and a partition 5A as a supporting portion for supporting the vibration plate 4 are increased gradually, preventing a crack caused by repeating operations.

Further, a slope 4A having a minute angle is formed in the foregoing connection portion.

The slope 4A allows the stress in the boundary (connection portion) between the partition 5A and the vibration plate 4 to be reduced.

Note that hereinafter portions of the vibration plate 4 are referred to as a vibration plate outer periphery 4a, a vibration plate intermediate portion 4b and a vibration plate central portion 4c in the order from the side of the connection portion with the partition 5A to the central portion.

In this example, the thickness of the vibration plate central portion 4c is, e.g., 0.4 μm, the thickness of the vibration plate intermediate portion 4b is 0.6 μm, and the thickness of the vibration plate outer periphery 4a is 0.8 μm.

Note that the thickness distribution of the vibration plate 4 may be in an angular multistage shape as shown in FIG. 3, and may also be in an elliptic multistage shape as shown in FIG. 4.

The vibration plate 4 is made of a boron doped layer 41 of a high concentration.

The boron doped layer 41 is formed by doping boron at a high concentration (about 5×10¹⁹ atoms/cm³ or more) and constitutes a so-called etching stop layer that causes the etch rate to become extremely low, e.g., when single-crystal silicon is etched with an alkaline aqueous solution.

The boron-doped layer 41 functions as such an etching stop layer, so that the thickness of the vibration plate 4 and the volume of the discharge chamber 5 can be formed with high precision.

The electrode glass substrate 2 is about 1 mm in thickness and bonded to the lower surface of the cavity substrate 1 as seen in FIG. 1.

Here, for example, borosilicate glass having a coefficient of thermal expansion close to that of silicon is used as glass of which the electrode glass substrate 2 is made.

In the case of using borosilicate glass, when the cavity substrate 1 and the electrode glass substrate 2 are bonded, displacement caused by heat can be prevented because their coefficients of expansion are not largely different.

In the electrode glass substrate 2, a recess 9 having a depth of about 0.2 μm is formed at a position facing each discharge chamber 5 formed in the cavity substrate 1.

Formed on the bottom surface of the recess 9 is a discrete electrode (counter electrode) 10 facing the vibration plate 4, forming a gap (void) G between the vibration plate 4 and the discrete electrode 10.

Note that the recess 9 is provided with the discrete electrode 10 on the bottom surface thereof, and therefore the pattern shape of the recess 9 should be made slightly larger than that of the electrode.

Here, the vibration plate 4 and the discrete electrode 10 that is disposed facing the vibration plate 4 and spaced apart therefrom by a certain distance (gap G) constitute an electrostatic actuator.

The electrostatic force generated by applying a voltage to between the vibration plate 4 and the discrete electrode 10 displaces the vibration plate 4.

Formed in the electrode glass substrate 2 is a recess 9A with a depth of about 0.2 μm extending from the recess 9 to an end of the electrode glass substrate 2, and formed on the bottom surface of the recess 9A are a lead 10a and a terminal 10b extending from the discrete electrode 10 (hereinafter, the whole of the discrete electrode 10, the lead 10a and the terminal 10b is referred to as an “electrode portion”).

The terminal 10b is exposed in a through hole 21, which is formed by opening an end of the cavity substrate 1 for wiring, and is connected via a flexible print circuit (FPC) (not shown) to the oscillation circuit 11, as shown in FIG. 2.

The oscillation circuit 11 controls supplying an electric charge to the discrete electrode 10 and stopping the supply through the terminal 10b.

The end of the gap G is filled with a sealing material 12 such that sealing is performed on the basis of each discrete electrode.

Sealing in this way prevents moisture from being adhered onto the bottom surface of the vibration plate 4 and the surface of the discrete electrode 10.

This is designed to prevent the discrete electrode 10 and the vibration plate 4 from being stuck to each other due to the moisture adhesion.

In the present embodiment, transparent indium tin oxide (ITO) doped with tin oxide as an impurity is used as a material for an electrode portion formed on the bottom surface of the recess 9 and is deposited to form a film having a thickness, e.g., of 0.1 μm in the recess 9 by sputtering.

Accordingly, the gap G formed between the vibration plate 4 and the discrete electrode 10 is defined by the depth of the recess 9 and the thickness of the electrode portion.

The gap G largely affects the discharge characteristics.

Here, the material for the electrode portion is not limited to ITO, and metals, such as chromium, and the like may be used as the material.

In the embodiment, ITO is used because of being transparent, which helps confirm whether discharging has been performed.

The electrode glass substrate 2 is provided with the ink supply ports 13 communicating with the reservoirs 6.

The nozzle substrate 3 is made, e.g., of a silicon substrate having a thickness of about 180 μm, and has nozzle holes 14 formed therein, which communicate with the discharge chambers 5.

Formed on the lower surface (surface on the side where the nozzle substrate is bonded to the cavity substrate 1) of the nozzle substrate 3 shown in FIG. 1 are orifices 15 for causing the discharge chambers 5 to communicate with the reservoirs 6.

Formed on both ends of the nozzle substrate 3 are diaphragms 16 that face the reservoirs 6 formed in the cavity substrate 1 and suppress the pressure fluctuation inside the reservoirs 6.

The diaphragms 16 are provided for the purposes of enhancing compliance of the reservoirs 6 and absorbing crosstalk during the drive of the inkjet head.

Operations of the inkjet head configured as described above are described.

The oscillation circuit 11 oscillates, e.g., at 24 kHz and applies pulse potentials of 0 V and 30 V to the discrete electrodes 10 to supply electric charges.

The oscillation circuit 11 is driven to supply electric charges to the discrete electrodes 10, so that the discrete electrodes 10 are positively charged.

In accordance with this, the vibration plates 4 are negatively charged and drawn to the discrete electrodes 10 due to the electrostatic force, so that the vibration plates 4 are bent.

As a result, the volumes of the discharge chambers 5 increase.

Then, when supplying electric charges to the discrete electrodes 10 is stopped, the vibration plates 4 return to their original states.

At this point, the volumes of the discharge chambers 5 also return to their original states.

The returning pressure causes ink droplets corresponding to the volume difference to be discharged.

These ink droplets land on, e.g., recording paper on which recording is performed, thus performing printing and the like.

Note that while such a method is of a so-called “draw fire” type, there is another type of method called a “push discharge” type method, in which droplets are discharged using a spring and the like.

Next, the vibration plates 4 are bent downward again, causing ink to be supplied from the reservoirs 6 through the orifices 15 into the discharge chambers 5.

Supplying ink to the inkjet head is performed by the ink supply ports 13 formed on the electrode glass substrate 2.

Here, in the inkjet head in this example, the vibration plate 4 is formed such that the vibration plate central portion 4c is thin, and therefore the entire rigidity of the vibration plate 4 is low as compared to the case where the entire vibration plate has the same thickness as that of the vibration plate outer periphery 4a.

Therefore, the stress on the vibration plate, which acts during driving the inkjet head, can be entirely relaxed, improving reliability of the vibration plate 4 in the long term.

As the vibration plate 4 is formed such that the thickness is increased gradually from the central portion toward the outer periphery, the strength of the vibration plate 4 is increased gradually toward the side of the connection portion (the boundary of the vibration plate 4 and the partition 5A) as compared to the case where the vibration plate 4 is simply and uniformly thin.

The durability of the vibration plate 4, which repeat operations, is improved.

In the inkjet head in this example, the slope 4A is provided at the boundary (connection portion) of the vibration plate 4 and the partition 5A, further enhancing the durability of the vibration plate 4.

The step structure of the vibration plate 4 is one where the thickness of the vibration plate 4 is increased gradually toward its outer periphery centering on its central portion.

Accordingly, the vibration plate 4 performs a deformation operation that is symmetric around its center, enabling the electrostatic actuator to be stably driven.

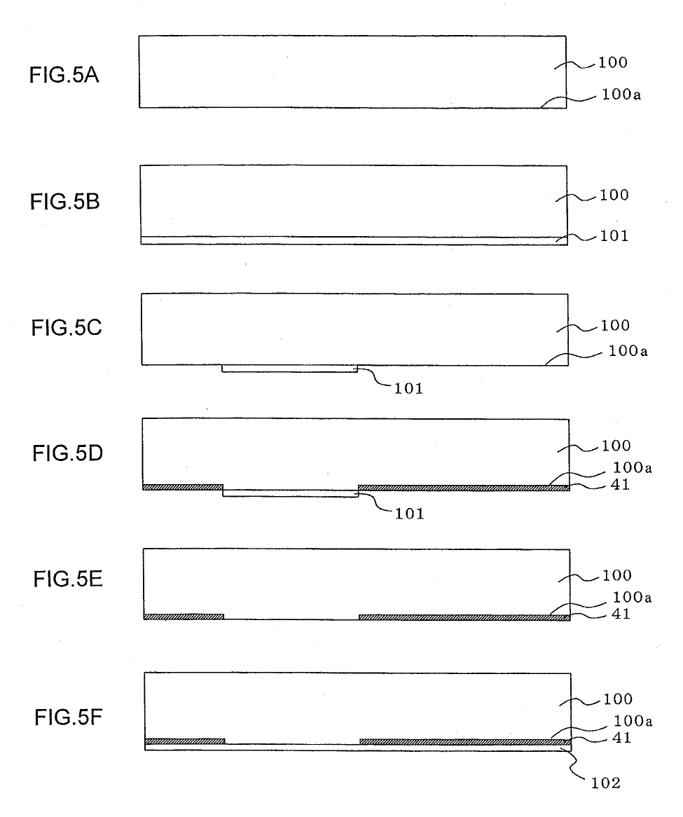

Referring to FIGS. 5A to 8N, a method for manufacturing an inkjet head of the embodiment will next be described.

Note that values of thicknesses of substrates, etching depth, temperature, pressure and the like are only illustrative, and the invention is not limited to these values.

Note also that although members for a plurality of inkjet heads are actually formed of a silicon substrate at one time, only part of them is shown in FIGS. 5A to 8N.

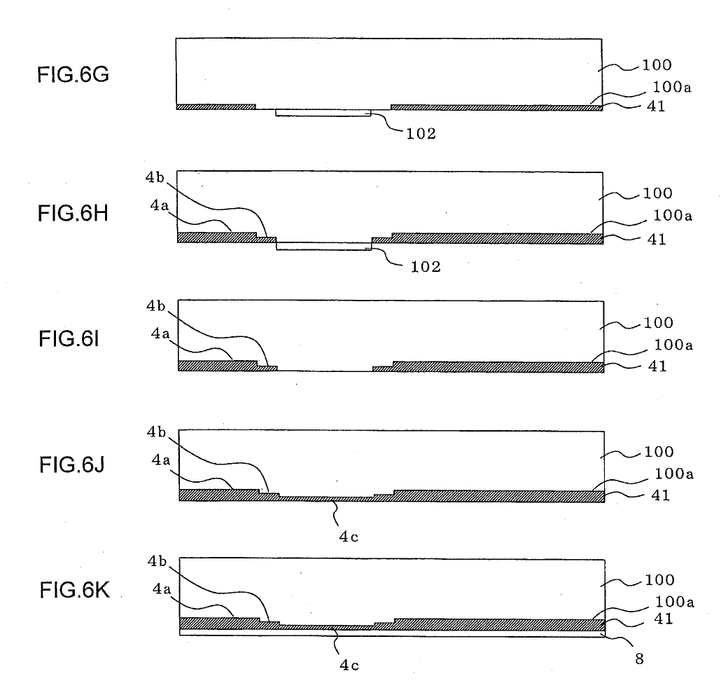

Referring to FIGS. 5A to 6K, a method for manufacturing the cavity substrate 1 before anodic bonding with the electrode glass substrate 2 is first described.

(A) A silicon substrate 100 having a surface orientation of (110) and a low oxygen concentration is prepared.

In the silicon substrate 100, a bond surface 100a to be bonded with the electrode glass substrate 2 is mirror-polished to produce a substrate having a thickness of 220 μm.

(B) A TEOS film 101 having a thickness of 1.0 μm is deposited on the face of the bond surface 100a of the silicon substrate 100 using plasma CVD under conditions where the treatment temperature is 360° C., the high-frequency output is 700 W, the pressure is 33.3 Pa (0.25 Torr) and, regarding the gas flow rate, the TEOS flow rate is 100 cm³/min (100 sccm) and the oxygen flow rate is 1000 cm³/min (1000 sccm).

(C) A resist is applied onto a surface of the silicon substrate 100 where the TEOS film 101 has been deposited.

Resist patterning is performed so that the TEOS film 101 is left behind only in a portion corresponding to the vibration plate central portion 4c and a portion corresponding to the vibration plate intermediate portion 4b.

Etching is performed with a hydrofluoric acid aqueous solution.

Thus, the TEOS film 101 is patterned.

Then, the resist is removed.

(D) The silicon substrate 100 is set on a quartz boat with the surface (the bond surface 100a) on the side where a boron-doped layer is to be formed facing a solid diffusion source whose main component is B₂0₃.

The quartz boat is set in a vertical furnace.

The inside of the furnace is in a nitrogen atmosphere, the temperature is increased to 1050° C. and this temperature is kept constant for two hours, and boron is diffused throughout the silicon substrate 100.

Thus, the boron doped layer 41 is formed in a portion that is not masked with the TEOS film 101, namely, a portion corresponding to the vibration plate outer periphery 4a and a portion located further outside it (a portion other than the discharge chamber 5).

In this boron-doping process, the temperature for placement of the silicon substrate 100 is set at 800° C., and the temperature for removing the silicon substrate 100 is also set at 800° C.

This enables the substrate to rapidly pass through a region (from 600° C. to 800° C.) where the growth rate of oxygen defects is high, and therefore generation of oxygen defects can be suppressed.

(E) Formed on the surface of the boron doped layer 41 is a boron compound (SiB₆) (not shown).

Oxidizing the compound for an hour and a half under conditions of an oxygen and water-vapor atmosphere and 600° C. can cause chemical change of the compound to B₂O₃+SiO₂ that can be etched by the use of a hydrofluoric acid aqueous solution.

Then, the silicon substrate 100 is immersed in a hydrofluoric acid aqueous solution for ten minutes.

As a result, B₂O₃+SiO₂ (not shown) on the surface of the boron doped layer 41 is removed by etching, and further the TEOS film 101 with which the portions corresponding to the vibration plate central portion 4c and the vibration plate intermediate portion 4b are masked is also removed by etching.

(F) Like the process (B), a TEOS film 102 having a thickness of 1.0 μm is deposited on the side of the bond surface 100a using plasma CVD under conditions where the treatment temperature is 360° C., the high-frequency output is 700 W, the pressure is 33.3 Pa (0.25 Torr) and, regarding the gas flow rate, the TEOS flow rate is 100 cm³/min (100 sccm) and the oxygen flow rate is 1000 cm³/min (1000 sccm).

(G) A resist is applied onto the surface of the silicon substrate 100 where the TEOS film 102 has been deposited.

Resist patterning is performed so that the TEOS film 102 is left behind only in a portion corresponding to the vibration plate central portion 4c.

Etching is performed with a hydrofluoric acid aqueous solution.

Thus, the TEOS film 102 is patterned.

Then, the resist is removed.

(H) The silicon substrate 100 is set on a quartz boat with the surface (the bond surface 100a) on the side where a boron-doped layer is to be formed facing a solid diffusion source whose main component is B₂0₃.

The quartz boat is set in a vertical furnace.

The inside of the furnace is in a nitrogen atmosphere, the temperature is increased to 1050° C. and this temperature is kept constant for two hours, and boron is diffused throughout the silicon substrate 100.

Thus, the surface is in a state where boron corresponding to diffusion for two hours is diffused in the portion corresponding to the vibration plate intermediate portion 4b and boron corresponding to diffusion for four hours is diffused in the portion located further outside the foregoing portion (the portion other than the discharge chamber 5).

Accordingly, the portion corresponding to the vibration plate outer periphery 4a and the portion located further outside the foregoing portion (the portion other than the discharge chamber 5) have boron concentrations higher than that of the portion corresponding to the vibration plate intermediate portion 4b, and in addition, they are in a state where boron is diffused into a more inner portion of the silicon substrate 100.

In the boron-doping process, the temperature for placement of the silicon substrate 100 is set at 800° C., and the temperature for removing the silicon substrate 100 is also set at 800° C.

This enables the substrate to rapidly pass through a region (from 600° C. to 800° C.) where the growth rate of oxygen defects is high, and therefore generation of oxygen defects can be suppressed.

(I) Formed on the surface of the boron doped layer 41 is a boron compound (SiB₆) (not shown).

Oxidizing the compound for an hour and a half under conditions of an oxygen and water-vapor atmosphere and 600° C. can cause chemical change of the compound to B₂O₃+SiO₂ that can be etched by the use of a hydrofluoric acid aqueous solution.

Then, the silicon substrate 100 is immersed in a hydrofluoric acid aqueous solution for ten minutes.

As a result, B₂O₃+SiO₂ (not shown) on the surface of the boron doped layer 41 is removed by etching, and further the TEOS film 102 with which the portions corresponding to the vibration plate central portion 4c and the vibration plate intermediate portion 4b are masked is also removed by etching.

(J) The silicon substrate 100 is set on a quartz boat with the surface (the bond surface 100a) on the side where a boron-doped layer is to be formed facing a solid diffusion source whose main component is B₂0₃.

The quartz boat is set in a vertical furnace.

The inside of the furnace is in a nitrogen atmosphere, the temperature is increased to 1050° C. and this temperature is kept constant for three hours, and boron is diffused throughout the silicon substrate 100.

Thus, the surface is in a state where boron corresponding to diffusion for three hours is diffused in the portion corresponding to the vibration plate central portion 4c, boron corresponding to diffusion for three hours is diffused in the portion corresponding to the vibration plate intermediate portion 4b, and boron corresponding to diffusion for seven hours is diffused in the portion corresponding to the vibration plate outer periphery 4a and the portion located further outside it (the portion other than the discharge chamber 5).

Accordingly, the portion corresponding to the vibration plate outer periphery 4a, the portion located further outside it (the portion other than the discharge chamber 5) and the portion corresponding to the vibration plate intermediate portion 4b have boron concentrations higher than that of the portion corresponding to the vibration plate central portion 4c, and in addition, they are in a state where boron is diffused into a more inner portion of the silicon substrate 100.

In the boron-doping process, the temperature for placement of the silicon substrate 100 is set at 800° C., and the temperature for removing the silicon substrate 100 is also set at 800° C.

This enables the substrate to rapidly pass through a region (from 600° C. to 800° C.) where the growth rate of oxygen defects is high, and therefore generation of oxygen defects can be suppressed.

(K) Formed on the surface of the boron doped layer 41 is a boron compound (SiB₆) (not shown).

Oxidizing the compound for an hour and a half under conditions of an oxygen and water-vapor atmosphere and 600° C. can cause chemical change of the compound to B₂O₃+SiO₂ that can be etched by the use of a hydrofluoric acid aqueous solution.

Then, the silicon substrate 100 is immersed in a hydrofluoric acid aqueous solution for ten minutes, and B₂O₃+SiO₂ on the entire surface of the boron doped layer 41 is removed by etching.

The TEOS insulating film 8 having a thickness of 0.1 μm is deposited on the surface on which the boron doped layer 41 has been formed by a plasma CVD method under conditions where the treatment temperature is 360° C., the high-frequency output is 250 W, the pressure is 66.7 Pa (0.5 Torr) and, regarding the gas flow rate, the TEOS flow rate is 100 cm³/min (100 sccm) and the oxygen flow rate is 1000 cm³/min (1000 sccm).

As described above, the process of selectively diffusing boron into the silicon substrate 100 is repeated to form, in advance, the vibration plate shape of the boron doped layer 41, and the silicon substrate 100 having the boron doped layer 41 formed therein is etched to leave the boron doped layer 41 behind, thereby forming the vibration plate 4 having a multistage shape.

Thus, the multistage shape can be formed with good precision.

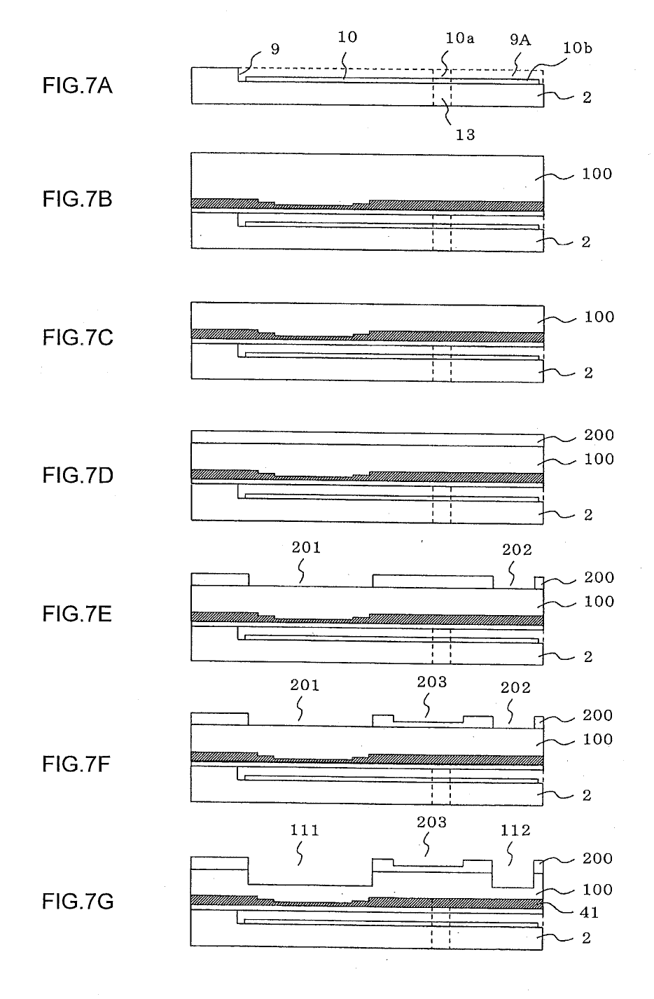

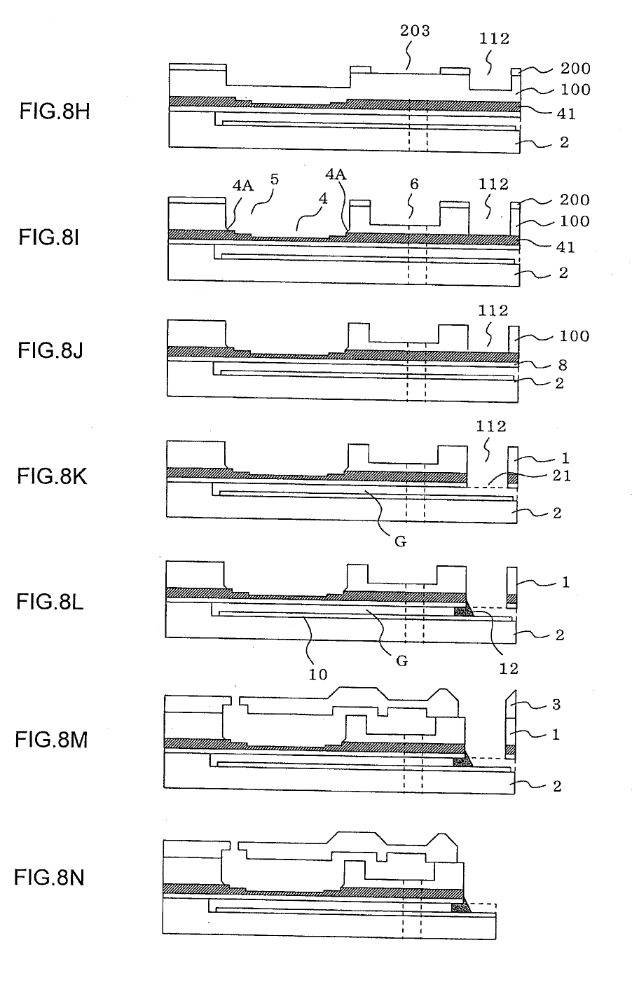

Referring to FIGS. 7A to 8N, manufacturing processes up to the completion of an inkjet head are next described.

(A) Here, the electrode glass substrate 2 is produced.

First, a glass substrate having a thickness of about 1 mm is prepared, and the recess 9 and the recess 9A having a depth of 0.2 μm is formed in accordance with the shape pattern of the discrete electrode 10.

In the recess 9 and the recess 9A, an electrode portion (the discrete electrode 10, the lead 10a and the terminal 10b) having a thickness of 0.1 μm is formed, e.g., by a sputtering method.

The ink supply port 13 is formed by a sandblasting method or cutting.

Thus, the electrode glass substrate 2 is produced.

(B) After the silicon substrate 100 produced by the manufacturing method shown in FIGS. 5A to 6K and the electrode glass substrate 2 are heated at 360° C., a negative electrode is connected to the electrode glass substrate 2 and a positive electrode is connected to the silicon substrate 100, and a voltage of 800 V is applied to perform anodic bonding.

(C) After the anodic bonding, cutting is performed until the thickness of the silicon substrate 100 reaches about 60 μm.

Thereafter, in order to remove a damaged layer, the silicon substrate 100 is etched for about 10 μm with a potassium hydroxide aqueous solution having a concentration of 32 wt %.

The resultant thickness of the silicon substrate 100 is about 50 μm.

(D) A TEOS etching mask 200 having a thickness of 1.0 μm is deposited on the entire surface opposite to the surface bonded to the electrode glass substrate 2 of the silicon substrate 100 using plasma CVD under conditions where the treatment temperature during deposition is 360° C., the high-frequency output is 700 W, the pressure is 33.3 Pa (0.25 Torr) and, regarding the gas flow rate, the TEOS flow rate is 100 cm³/min (100 sccm) and the oxygen flow rate is 1000 cm³/min (1000 sccm).

(E) The TEOS etching mask 200 is patterned using resist patterning and etched with a hydrofluoric acid aqueous solution, so that a portion 201 that is to constitute the discharge chamber 5 and a portion 202 that is to constitute a through hole (serving as a through hole for electrode extraction and a through hole for sealing) 21 are patterned.

Then, the resist is removed.

(F) The TEOS etching mask 200 is patterned using resist patterning and etched only for a thickness of 0.7 μm with a hydrofluoric acid aqueous solution, so that a portion 203 that is to constitute the reservoir 6 is patterned.

The remaining thickness of the portion 203, which is to constitute the reservoir, of the TEOS etching mask 200 is 0.3 μm.

This is for the purpose of causing the reservoir 6 to have a large thickness in the end so as to improve the rigidity of the reservoir 6.

Then, the resist is removed.

(G) The bonded substrate is immersed in a potassium hydroxide aqueous solution having a concentration of 35 wt % and etched using the TEOS etching mask 200 until the thicknesses of a portion 111 that is to constitute the discharge chamber 5 and a portion 112 that is to constitute the through hole 21 reach about 10 μm.

Etching has not yet begun for the portion 203 that is to constitute the reservoir 6.

In this etching process, the potassium hydroxide aqueous solution enters from the ink supply ports 13 of the electrode glass substrate 2, so that portions corresponding to the ink supply ports 13 are etched on the bond surface, which is to be bonded to the electrode glass substrate 2, of the silicon substrate 100.

Note that since the boron doped layer 41 is formed on the bond surface, which is to be bonded with the electrode glass substrate 2, of the silicon substrate 100, the etching rate is reduced in the portion of the boron doped layer 41.

However, a potassium hydroxide aqueous solution having a high concentration is used for etching performed here, and therefore etching pierces the boron doped layer 41 and further proceeds to the inside of the silicon substrate 100.

(H) In order to remove the TEOS etching mask 200 of the portion 203 that is to constitute the reservoir 6, the bonded substrate is immersed in a hydrofluoric acid aqueous solution.

(I) The bonded substrate is immersed in a potassium hydroxide aqueous solution having a concentration of 3 wt %, and etching is continued until etching stop caused by reduction in etching rate in the boron doped layer 41 has a sufficient effect.

This causes the vibration plate 4 to be formed and also causes the discharge chamber 5 and the reservoir 6 to be formed.

In this way, etching using the foregoing two kinds of potassium hydroxide aqueous solutions having different concentrations is performed, enabling surface roughness of the vibration plate 4 to be suppressed.

Regarding the thickness of the vibration plate 4, the thickness of the vibration plate central portion 4c is 0.4 μm, the thickness of the vibration plate intermediate portion 4b is 0.6 μm, and the thickness of the vibration plate outer periphery 4a is 0.8 μm.

Due to the use of a boron etching stop technique, the thickness can be controlled with high precision, allowing the discharge performance of an inkjet head to be stabilized.

Note that the reservoir 6 has a thickness of about 10μ, so that its rigidity is improved as compared to the vibration plate 4 and the portion 112 that is to constitute the through hole 21.

In the foregoing etching processes in forming the vibration plate 4, first in the process (G), etching is performed up to the vicinity of the boron doped layer 41 by using a potassium hydroxide aqueous solution having a high concentration, and in the process (I), etching is performed by using a potassium hydroxide aqueous solution having a low concentration until etching stop of the boron doped layer 41 has a sufficient effect.

Such an etching method is disclosed in JP-A-11-129473.

Employing this technique allows formation of the slope 4A in the connection portion between the vibration plate 4 and the partition 5A.

This slope 4A has an effect of reducing the stress acting on the boundary (the connection portion) of the vibration plate 4 and the partition 5A.

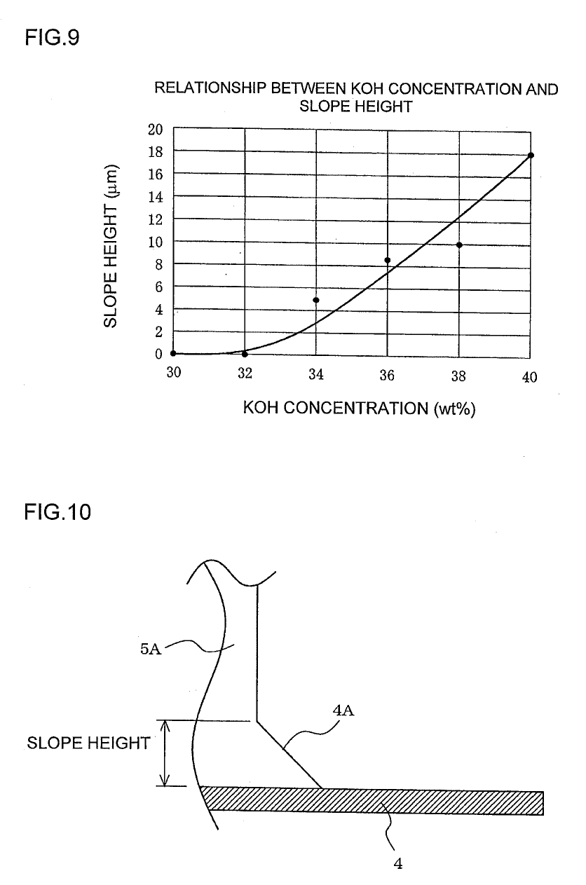

FIG. 9 is a graph showing a relationship between the height of a slope formed in a connection portion of a vibration plate and a partition and the potassium hydroxide (KOH) concentration.

FIG. 10 is an explanatory view of the height of the slope in FIG. 9 and is a sectional view showing the enlarged portion of the vibration plate and the slope.

As shown in FIG. 9, when KOH concentration is 30 wt % or more, a slope is formed.

In this example, initial etching using KOH having a concentration of 35 wt % forms a slope having a height of about 6 μm.

The next etching using KOH having a concentration of 3 wt % reduces the slope height to leave the slope 4A having a minute angle behind.

Description on the manufacturing processes is continued below.

(J) When etching finishes, the bonded substrate is immersed in a hydrofluoric acid aqueous solution to remove the TEOS etching mask 200 on the surface of the silicon substrate 100.

(K) In order to remove a silicon thin film and the insulating film 8 remaining in the portion 112, which is to constitute the through hole (serving as the through hole for electrode extraction and the through hole for sealing) 21, a silicon mask (not shown) having an opened portion corresponding to the portion 112 that is to constitute the through hole 21 is attached to the surface of the silicon substrate 100.

Dry etching of reactive ion etching (RIE) is performed for one hour under conditions where the radio frequency (RF) power is 200 W, the pressure is 40 Pa (0.3 Torr), and the CF₄ flow rate is 30 cm³/min (30 sccm), and plasma is applied only to the portion 112 that is to constitute the through hole 21, thereby forming an opening.

At this point, the gap G is opened to the atmosphere.

As described above, the cavity substrate 1 is produced.

(L) After water in the gap G is removed and the gap G is made hydrophobic, an end of the gap G is filled with the sealing material 12, e.g., of epoxy resin to perform sealing for each discrete electrode 10.

(M) The nozzle substrate 3 is adhered to the top surface of the cavity substrate 1 with an epoxy adhesive.

(N) Dicing is performed to cut the member into individual heads.

By the above manufacturing method, an inkjet head with the vibration plate 4 in a three-stage structure whose thickness is increased gradually toward its outer periphery centering on the vibration plate central portion 4c is completed.

As described above, etching of the silicon substrate 100 is performed in two phases using high-concentration and low-concentration potassium hydroxide aqueous solutions, thereby forming the slope 4A with a minute angel in the connection portion between the vibration plate 4 and the partition 5A.

This slope 4A can reduce the stress on the connection portion, enabling improvement in durability of the vibration plate 4 for repeating operations.

The method of forming portions such as the discharge chamber 5 after bonding the silicon substrate 100 and the electrode glass substrate 2 is used.

This facilitates handling the substrate, allowing cracking in the substrate to be reduced and the size of the substrate to be increased.

Increase in substrate size allows more inkjet heads to be made from one substrate, leading to improvement in productivity.

While a method for manufacturing an inkjet head has been described in the foregoing embodiment, the invention is not limited to the foregoing embodiment and various changes can be devised within the scope of the idea of the invention.

For example, changing the liquid material discharged from the nozzle hole 14 enables the inkjet head to be utilized as a droplet discharge device for various applications such as manufacture of a color filter of a liquid crystal display, formation of a light-emitting portion of an organic electroluminescent (EL) display, and manufacture of a microarray of a bimolecular solution used for genetic screening, in addition to an inkjet printer.

What is claimed is:

1. An electrostatic actuator, comprising:
a vibration plate; and
a counter electrode facing the vibration plate and spaced apart therefrom by a gap;
wherein the vibration plate is in a multistage shape in such a manner that a thickness is increased gradually from a central portion toward an outer periphery of the vibration plate.

2. The electrostatic actuator according to claim 1, wherein a slope is formed in a connection portion of the vibration plate and a portion supporting the vibration plate.

3. The electrostatic actuator according to claim 1, wherein the vibration plate is made of a boron-doped silicon substrate.

4. The electrostatic actuator according to claim 1, wherein an electrode substrate on which the counter electrode is formed is made of borosilicate glass.

5. The electrostatic actuator according to claim 1, wherein the counter electrode is made of indium tin oxide (ITO).

6. A droplet discharge head comprising the electrostatic actuator according to claim 1, wherein the vibration plate constitutes a bottom wall of a discharge chamber for discharging a droplet.

7. A method for manufacturing an electrostatic actuator, comprising:
forming a boron-doped layer by repeating a process of selectively diffusing boron into a silicon substrate; and
forming a vibration plate by wet etching the silicon substrate having the boron-doped layer formed therein and stopping the etching with the boron-doped layer.

8. The method for manufacturing an electrostatic actuator according to claim 7, wherein the wet etching is performed using potassium hydroxide aqueous solutions having different concentrations.

9. A method for manufacturing a droplet discharge head, comprising forming an actuator portion of the droplet discharge head by applying the method for manufacturing an electrostatic actuator according to claim 7.
